(19) United States
(12) Patent Application Publication
(10) Pub. No.: US 2024/0422799 A1
(43) Pub. Date: Dec. 19, 2024

(54) COEXISTENCE OF DIFFERENT SIDELINK PROTOCOLS

(71) Applicant: ZTE Corporation, Shenzhen (CN)

(72) Inventors: Wei LUO, Shenzhen (CN); Lin CHEN, Shenzhen (CN)

(21) Appl. No.: 18/812,536

(22) Filed: Aug. 22, 2024

Related U.S. Application Data
(63) Continuation of application No. PCT/CN2022/089115, filed on Apr. 25, 2022.

(51) Int. Cl. H04W 72/25

(52) U.S. Cl. CPC H04W 72/25

(57) ABSTRACT

This disclosure is directed to methods, systems, and devices related to wireless communication. A method of wireless communication, comprising: transmitting, by a wireless communication device, to a network device, a sidelink coexistence assistance information; receiving, by a wireless communication device, from the network device, a configuration message according to the sidelink coexistence assistance information; wherein the wireless communication device is in Radio Resource Control (RRC) connected state.

### CROSS-REFERENCE TO RELATED APPLICATION

This application is a continuation and claims priority to International Application No. PCT/CN2022/089115, filed on Apr. 25, 2022, the disclosure of which is hereby incorporated by reference herein in its entirety.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), 4th Generation (4G), and long-term evolution (LTE) communication systems with respect to reporting or using channel state information.

In one example aspect, a wireless communication method is disclosed. The method includes transmitting, by a wireless communication device, to a network device, a sidelink coexistence assistance information; receiving, by a wireless communication device, from the network device, a configuration message according to the sidelink coexistence assistance information; wherein the wireless communication device is in Radio Resource Control (RRC) connected state.

In another example aspect, another wireless communication method is disclosed. The method includes acquiring, by a wireless communication device, a first sidelink resource pool, a second sidelink resource pool, and a plurality of sensing results; wherein the first sidelink resource pool and the second sidelink resource pool have different RAT indications; wherein a plurality of sensing results associated the first sidelink resource pool and the second sidelink resource pool; selecting, by the wireless communication device, sidelink resource according to the sensing results.

In another example aspect, another wireless communication method is disclosed. The method includes transmitting, by a first wireless communication device, to a second wireless communication device, coexistence interference indication; receiving, by the first wireless communication device, from the second wireless communication device, assistance information; transmitting, by the first wireless communication device, to a network device, the received assistance information; wherein, the first wireless communication device is in Radio Resource Control (RRC) connected state.

In another example aspect, another wireless communication method is disclosed. The method includes receiving, by a wireless communication device, from the network device, a third configuration message; determining, by a wireless communication device, to perform sidelink transmission.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 shows an example of a wireless communication system that includes a base station (BS) and user equipment (UE).

FIG. 2 is a block diagram example of a wireless communication system.

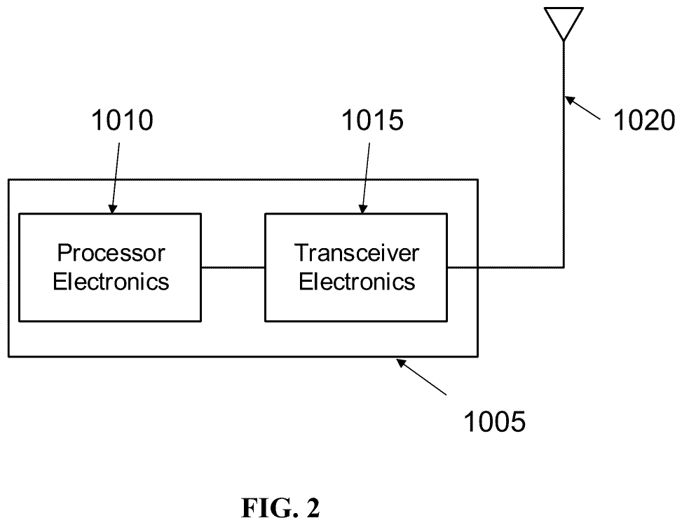

FIG. 3 shows an example scenario of V2X sidelink communication/discovery.

FIG. 4 is a flowchart illustrating an example method.

FIG. 5 is a flowchart illustrating an example method.

FIG. 6 is a flowchart illustrating an example method.

FIG. 7 is a flowchart illustrating an example method.

FIG. 8 is a flowchart illustrating an example method.

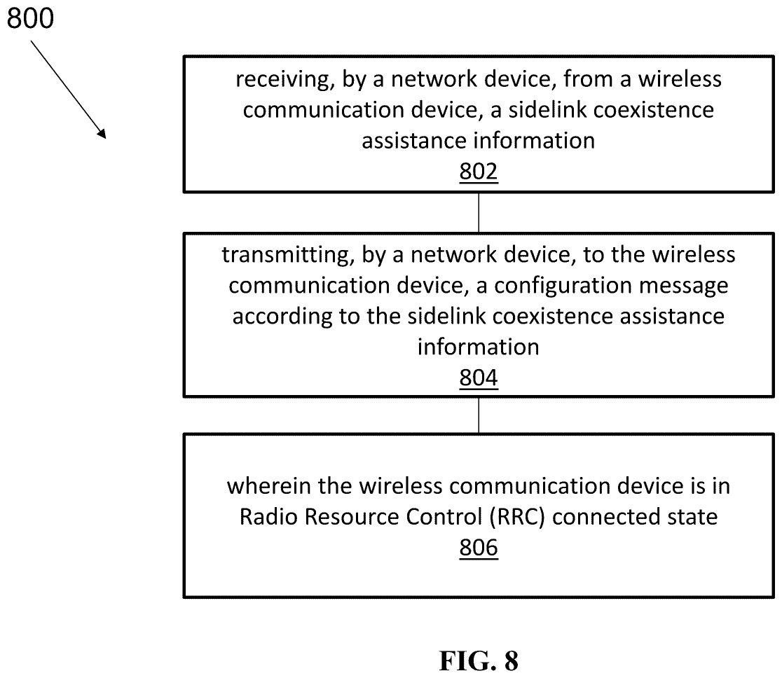

FIG. 9 is a flowchart illustrating an example method.

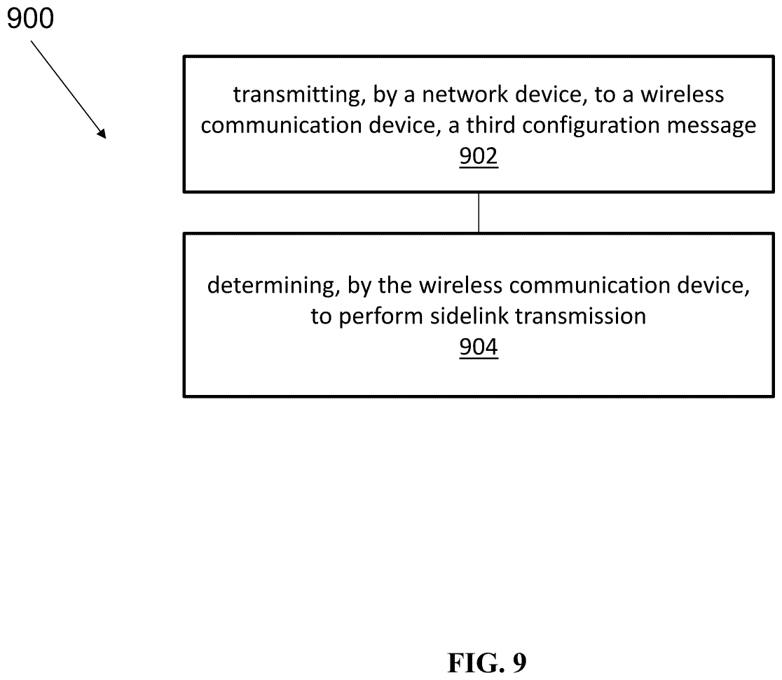

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

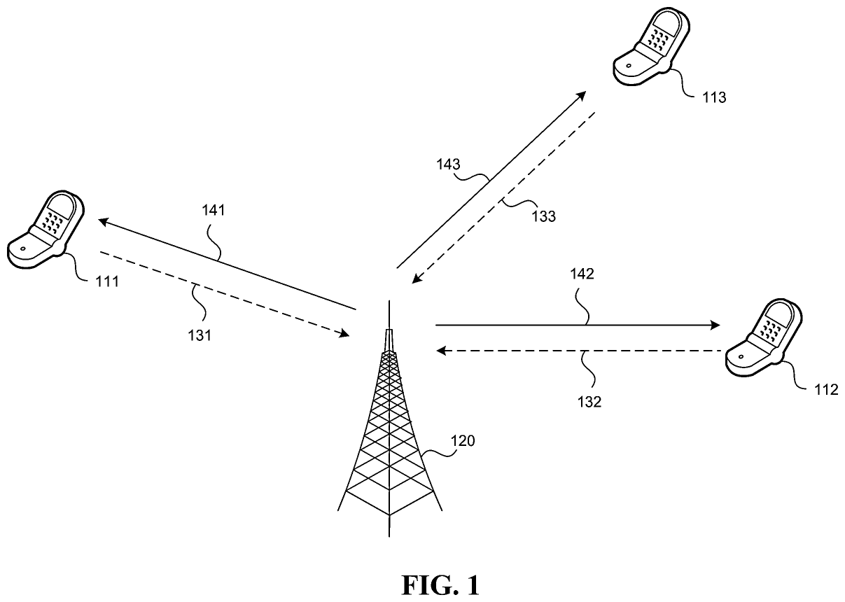

FIG. 1 shows an example of a wireless communication system (e.g., a long-term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

This disclosure is directed to methods, systems, and devices related to wireless communication.

Sidelink is a unilateral wireless communication service, e.g., the communication between the communication terminals without forwarding through a network node such as a base station. Vehicle networking refers to a large-scale system for wireless communication and information exchange among vehicles, pedestrians, roadside equipment, and internet in accordance with agreed communication protocols and data exchange standards. Vehicle networking communications enable the vehicles to gain driving safety, improve traffic efficiency, and acquire convenience or entertainment information. Vehicle networking communication may be categorized into three types as per the objects of wireless communication: the communication between vehicles, i.e., vehicle-to-vehicle (V2V); the communication between vehicles and roadside equipment/network infrastructures, e.g., vehicle-to-infrastructure/vehicle-to-network (V2I/V2N); and the communication between vehicles and pedestrians, i.e., vehicle-to-pedestrian (V2P). These types of communications collectively are referred to as vehicle-to-everything (V2X) communication.

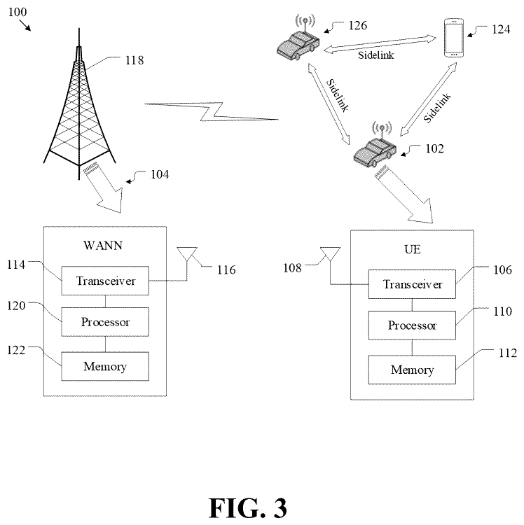

In the V2X protocol of 3rd Generation Partnership Project (3GPP), the sidelink based V2X communication method between UEs is one way to implement the V2X standard in which traffic data is directly transmitted from a source UE to a destination UE via an air interface without forwarding by the base station and the core network, as shown in FIG. 3. This V2X communication is referred to as PC5-based V2X communication or V2X sidelink communication.

With the technology advancement and development in the automation industry, uses cases for V2X communications have further diversified and will require higher performance that existing V2X methods. These advanced V2X services may include vehicle platooning, extended sensors, advanced driving (e.g., semi-automated driving and full-automated driving), and remote driving. The desired performance requirements may include supporting data packet with the size of 50 to 12000 bytes, transmission rate with 2 to 50 messages per second, the maximum end-to-end delay of 3 to 500 milliseconds, reliability of 90% to 99.999%, data rate of 0.5 to 1000 Mbps, as well as transmission range of 50 to 1000 meters.

FIG. 3 shows an example scenario of V2X sidelink communication/discovery.

3GPP has approved the research on vehicle networking communication based on NR. However, as a widely used technology, LTE will not be replaced immediately, but will coexistence with NR technology for a considerable period of time. In the future, terminals supporting NR capability and LTE capability will exist together. How to ensure reasonable communication between them and how to allocate resources are urgent problems to be solved. The present document proposes a v2x resource allocation scheme based on the coexistence of multiple systems.

### Embodiment 1

When NR sidelink and LTE sidelink work on the overlapped carrier/band or adjacent carrier/band to each other they may have strong interference to each other. If the UE cannot solve the interference problem by itself, it may need assistance from the network.

In some embodiments, when UE is in radio resource control (RRC) connected and configured with mode 1:

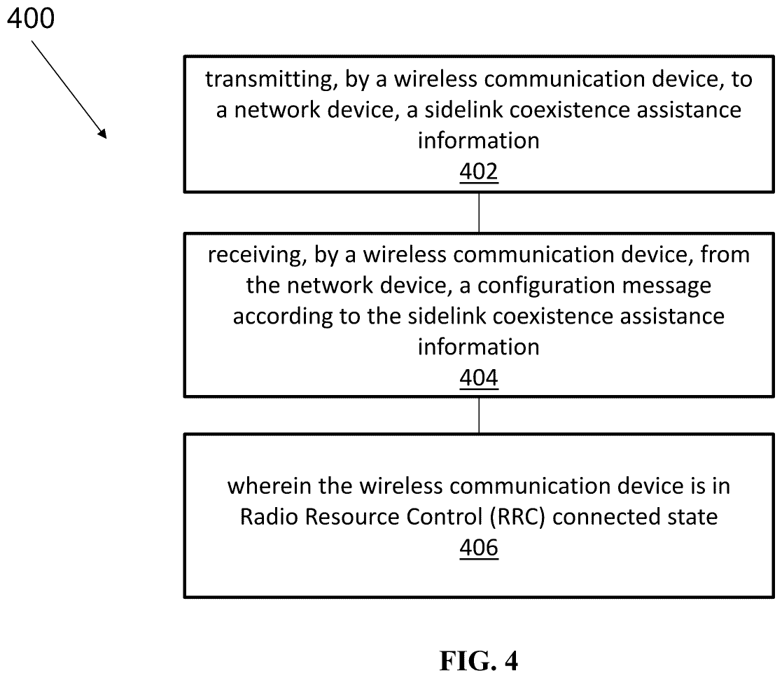

FIG. 4 illustrates a wireless communication, comprising: transmitting, by a wireless communication device, to a network device, a sidelink coexistence assistance information (402); receiving, by a wireless communication device, from the network device, a configuration message according to the sidelink coexistence assistance information (404); wherein the wireless communication device is in Radio Resource Control (RRC) connected state (406).
Step 1a: UE reports a capability message which indicates that the UE supports the capability of LTE sidelink and NR sidelink coexistence to the network; or:
Step 1b: UE reports to the network the sidelink information or UE assistance information which indicates the UE has both the LTE sidelink and NR sidelink traffic.
Step 2 (optional): UE receives a first configuration message from the network. The first configuration message can indicate whether the UE is configured to provide NR and LTE sidelink coexistence assistance information to the network. For example:
1> if the received otherConfig includes the slcoexistence-AssistanceConfig:
   2> if slcoexistence-AssistanceConfig is set to setup:
      3> consider itself to be configured to provide NR and LTE sidelink coexistence assistance information.
   2> else:
      3> consider itself not to be configured to provide NR and LTE sidelink coexistence assistance information.

In some embodiments, UE reports NR and LTE sidelink coexistence assistance information when the UE is experiencing NR and LTE sidelink coexistence interference problems that it cannot be solved by itself. NR and LTE sidelink coexistence assistance information includes one of:
carrierFreq: indicate the carrier which experiencing NR and LTE sidelink coexistence interference problems
ResourcePoolList: indicate the Resource Pool identity which experiencing NR and LTE sidelink coexistence interference problems
interferenceDirection: indicate the interference Direction of NR and LTE sidelink, the direction can indicate NR sidelink interfere the LTE sidelink or indicate LTE sidelink interfere the NR sidelink or indicate both of them.
victimSystemType: indicate the victim System is NR sidelink or LTE sidelink
Subbandindex list: indicate the Subband index list which experiencing NR and LTE sidelink coexistence interference problems
BWPindex list: indicate the BWP index list which experiencing NR and LTE sidelink coexistence interference problems.

For example, the configured IE (information element) list can be as following: carrierFreq ARFCN-ValueNR,
ResourcePoolList::=SEQUENCE (SIZE (1 . . . maxSL-Pool)) OF SL-ResourcePoolID−interferenceDirection ENUMERATED {nr, lte, both, spare}
victimSystemType ENUMERATED {nr sidelink, lte sidelink, spare}
Subbandindex list::=SEQUENCE (SIZE (1 . . . maxSL-Subband)) OF Subbandindex
BWPindex list::=SEQUENCE (SIZE (1 . . . maxSL-BWP)) OF BWPindex

In addition, if the UE finds that the UE is able to resolve the NR and LTE sidelink coexistence interference or if the NR/LTE coexistence issue does not exist, it can also report the NR and LTE sidelink coexistence assistance information to let the network know about the condition.

In some embodiments, when a UE connected with a gNB, the NR and LTE sidelink coexistence assistance information includes LTE sidelink resource pool configuration information.
Step 3a: UE reports NR and LTE sidelink coexistence assistance information when following conditions are met: UE is configured with both NR sidelink and LTE sidelink, and NR sidelink and LTE sidelink work on the overlapped carrier/BWP/sub-band or adjacent carrier/BWP/sub-band to each other;
Step 3b: UE reports NR and LTE sidelink coexistence assistance information when following conditions are met: UE is configured with both NR sidelink and LTE sidelink, and the active time of NR sidelink and the time of resource pool of LTE sidelink are overlapped.
Step 4: UE receives a second configuration message from the network.

The second configuration message may include configuration information used for sensing, which includes at least one of:
Resource pool id: indicates which Tx resource pool is needed to be sensed;
sensingSubchannelNumber: Indicates the number of sub-channels;
sensingPeriodicity: Indicate the resource reservation interval used for the sensing;
sensingPriority: Indicate the priority for sensing;
RAT indication: Indicates which RAT of sidelink resource pool is to be sensed.
resource type indication: Indicates preferred or non-preferred resource to be reported.

In some embodiments, the second configuration information includes at least one of NR sidelink configuration information, LTE sidelink configuration information. NR sidelink configuration information or LTE sidelink configuration information. The information may include at least one of:
Resource pool id: indicates which Tx resource pool is to be sensed.
sensingSubchannelNumber: Indicates the number of sub-channels.
sensingPeriodicity: Indicates the resource reservation interval.
sensingPriority: Indicates the priority for sensing;
resource type indication: Indicates preferred or non-preferred resource to be reported.

In some embodiments, the second configuration message may include configuration information used for report sensing result including at least one of:
Report period T1:
Trigger event: for example, include CBR Threshold C1 and/or C2.
Step 5: The UE performs sensing based on the received configuration information used for sensing.
Step 6: the UE report the sensing result based on the received second configuration information.

In some embodiments, if the measured CBR is higher than the CBR Threshold C1, or the CBR is lower than the CBR Threshold C2, the UE reports the sensing result in case of the received second configuration including CBR Threshold C1 and/or C2.

In some embodiments, the UE reports the sensing result every T1 time in case of the received second configuration including Report period T1.

The sensing result may include at least one of the available resource candidates; or the unavailable resource.

The sensing result may include at least one of resource Index; sl-SubframeRef; RAT indication; or resource type.

resourceIndex: Indicates the available or unavailable resource candidates. A Value 1 indicates the resource on the subframe indicated by sl-SubframeRef, from subchannel 0 to sensingSubchannelNumber−1. A Value 2 indicates the resource on the first subframe following the subframe indicated by sl-SubframeRef, from subchannel 0 to sensingSubchannelNumber−1 (A Value 101 indicates the resource on the subframe indicated by sl-SubframeRef, from subchannel 1 to sensingSubchannelNumber, if the numSubchannel of the resource pool is larger than sensingSubchannelNumber) and so on.

If the sensing result includes the available resource candidates, resourceIndex may indicate the available resource candidates.

If the sensing result includes the unavailable resource, resource Index may indicate the unavailable resource.

sl-SubframeRef: Indicates the subframe corresponding to n+T1 used to obtain the sensing measurement results. In some embodiments, the value indicates the timing offset with respect to subframe #0 of DFN #0 in milliseconds.

RAT indication: Indicates which RAT of sidelink resource pool is. NR indicates NR sidelink resource pool. LTE indicates LTE sidelink resource pool.

Resource type: Indicates that the indicated resource is available resource candidates or unavailable resource.

In some embodiments, when the UE is connected with a gNB, it only needs to report the sensing result of LTE sidelink resource pool.

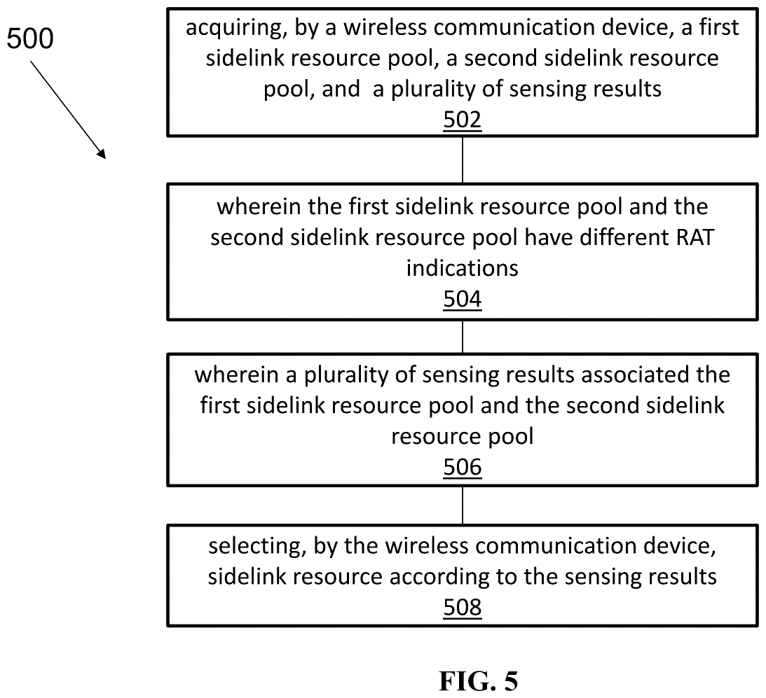

FIG. 5 illustrates a wireless communication comprising: acquiring, by a wireless communication device, a first sidelink resource pool, a second sidelink resource pool, and a plurality of sensing results (502), wherein the first sidelink resource pool and the second sidelink resource pool have different RAT indications (504); wherein a plurality of sensing results associated the first sidelink resource pool and the second sidelink resource pool (506); selecting, by the wireless communication device, sidelink resource according to the sensing results (508).

### Embodiment 2

In some embodiments, when UE is in RRC connected and configured with mode 2:
Step 1a: UE reports the capability message which indicates the UE support the capability of LTE sidelink and NR sidelink coexistence to the network; or
Step 1b: UE reports the sidelink information or UE assistance information which indicates the UE has both the LTE sidelink and NR sidelink traffic to the network.
Step 2 (optional): UE receives a first configuration message from the network. The first configuration message can indicate whether the UE is configured to provide NR and LTE sidelink coexistence assistance information to the network. For example:
1> if the received otherConfig includes the slcoexistence-AssistanceConfig:
   2> if slcoexistence-AssistanceConfig is set to setup:
      3> consider itself to be configured to provide NR and LTE sidelink coexistence assistance information.
   2> else:
      3> consider itself not to be configured to provide NR and LTE sidelink coexistence assistance information.
Step 3: UE reports NR and LTE sidelink coexistence assistance information when the UE is experiencing NR and LTE sidelink coexistence interference problems that it cannot be solved by itself. NR and LTE sidelink coexistence assistance information include one of:
carrierFreq: indicate the carrier which experiencing NR and LTE sidelink coexistence interference problems
ResourcePoolList: indicate the Resource Pool identity which experiencing NR and LTE sidelink coexistence interference problems
interferenceDirection: indicate the interference Direction of NR and LTE sidelink, the direction can indicate NR sidelink interfere the LTE sidelink or indicate LTE sidelink interfere the NR sidelink or indicate both of them.
victimSystemType: indicate the victim System is NR sidelink or LTE sidelink
Subbandindex list: indicate the Subband index list which experiencing NR and LTE sidelink coexistence interference problems
BWPindex list: indicate the BWP index list which experiencing NR and LTE sidelink coexistence interference problems.

For example, the configured IE (information element) list can be as following:
carrierFreq ARFCN-ValueNR,
ResourcePoolList::=SEQUENCE (SIZE (1 . . . maxSL-Pool)) OF SL-ResourcePoolID−interferenceDirection ENUMERATED {nr, lte, both, spare}
victimSystemType ENUMERATED {sidelink, spare}—indicate the victim System is NR or LTE sidelink
Subbandindex list::=SEQUENCE (SIZE (1 . . . maxSL-Subband)) OF Subbandindex
BWPindex list::=SEQUENCE (SIZE (1 . . . maxSL-BWP)) OF BWPindex

In addition, if the UE determines that the NR and LTE sidelink coexistence interference problems can be resolved by the UE or the problem does not exist, it can also report the NR and LTE sidelink coexistence assistance information to tell the network.
Step 3a: UE reports NR and LTE sidelink coexistence assistance information when following conditions are met: UE is configured with both NR sidelink and LTE sidelink, and NR sidelink and LTE sidelink work on the overlapped carrier/BWP/sub-band or adjacent carrier/BWP/sub-band to each other.
Step 3b: UE reports NR and LTE sidelink coexistence assistance information when the following conditions are met: UE is configured with both NR sidelink and LTE sidelink, and the active time of NR sidelink and the time of resource pool of LTE sidelink are overlapping.

After that, the network can reconfigure the sidelink transmission or reception resource pool for the UE.

### Embodiment 3

When the UE is in RRC IDLE or RRC inactive, or when UE is in RRC connected and configured with mode 2, or when the UE is out of coverage, and that UE selects sidelink resource by its own.

UE considers the sensing results for the associated NR sidelink resource pool when performing NR sidelink resource selection.

When UE is configured with NR sidelink and LTE sidelink, UE considers both sensing results of the associated NR sidelink resource pool and LTE sidelink resource pool when performing NR or LTE sidelink resource selection.

In some embodiments, the sensing results of the associated NR sidelink resource pool or LTE sidelink resource pool provides UE available/unavailable resources.

In some embodiments, when UE performs NR sidelink resource selection, it selects sidelink resource according to the sensing results of the associated NR sidelink resource pool and LTE sidelink resource pool. The sensing results of the associated NR sidelink resource pool provide available resources, and the sensing results of the LTE sidelink resource pool provide unavailable resources.

In some embodiments, when UE performs LTE sidelink resource selection, it selects sidelink resource according to the sensing results of the associated LTE sidelink resource pool and NR sidelink resource pool. The sensing results of the associated LTE sidelink resource pool provide candidate available resources, and the sensing results of the NR sidelink resource pool provide unavailable resources.

After UE selects sidelink resource, if UE determines that selected transmission(s) based on selected sidelink may interfere LTE or NR sidelink reception, UE triggers reselection process of the TX resource.

In some embodiments, before step 1 (reports the capability message), UE receives indication information from the network. Indication information includes that UE is allowed to trigger the TX resource reselection process if UE determines that selected transmission(s) based on selected sidelink may interfere LTE or NR sidelink reception.

In some embodiments, UE is implemented to determine whether selected transmission(s) based on selected sidelink may interfere with LTE or NR sidelink reception.

In some embodiments, UE determines selected transmission(s) based on selected NR sidelink that may interfere with LTE sidelink reception when the selected sidelink is out of the range of the available LTE sidelink transmission resources, or the selected sidelink grant fall in the range of the available LTE sidelink transmission resources.

In some embodiments, UE determines selected transmission(s) based on selected NR sidelink that may interfere with NR sidelink reception when the selected sidelink is out of the range of the available NR sidelink transmission resources, or that the selected sidelink grant fall within the range of the NR sidelink reception resources or NR sidelink DRX active time.

### Embodiment 4

When a first UE is communicated with a second UE via sidelink unicast.

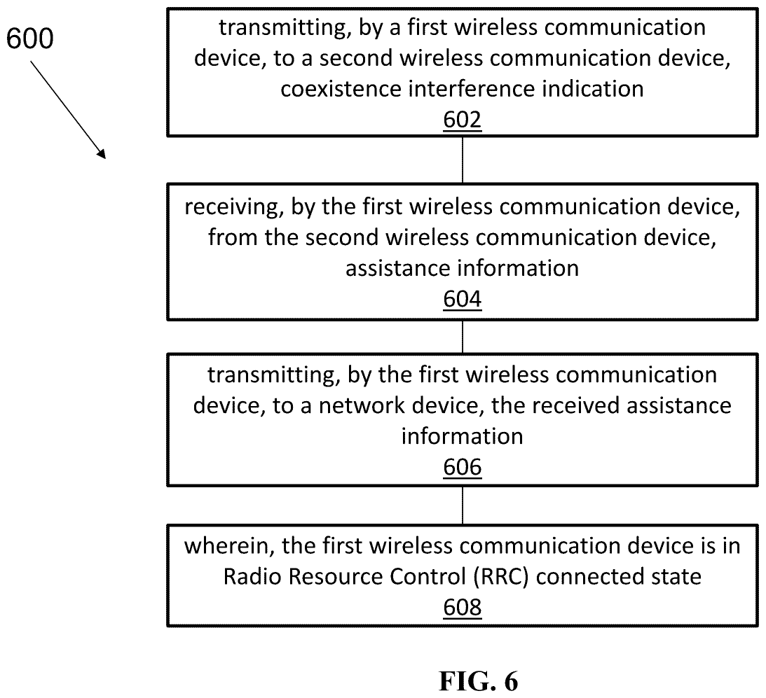

FIG. 6 illustrates a wireless communication comprising transmitting, by a first wireless communication device, to a second wireless communication device, coexistence interference indication (602); receiving, by the first wireless communication device, from the second wireless communication device, assistance information (604); transmitting, by the first wireless communication device, to a network device, the received assistance information (606); wherein, the first wireless communication device is in Radio Resource Control (RRC) connected state (608).
Step 1: when the first UE experience NR and LTE sidelink coexistence interference problems that cannot be resolve on its own, the first UE sends NR and LTE sidelink coexistence interference indication to the second UE. NR and LTE sidelink coexistence interference indication includes at least one of the following:
NR and LTE sidelink coexistence interference exist indication
Subband or BWP index list may be interfered
Slot or subframe index may be interfered
Step 2: the second UE send assistance information to the first UE. The assistance information includes at least one of the following:
NR sidelink transmission resource pool configuration
LTE sidelink transmission resource pool configuration
Subband or BWP index list may be used for sidelink transmission
Slot or subframe index may be used for sidelink transmission
Step 3 (optional): if the first UE is in RRC connected, it sends the received assistance information from the second UE to the network. It can also send both the received assistance information and the associated destination ID to the network.

When the network allocates sidelink resource to the first UE, the network may take the above information into consideration. For example, the allocated sidelink transmission resource may not be within the range of the NR or LTE sidelink transmission resource pool, or the allocated sidelink transmission resource may not be within the range of Sub-band index or slot index or subframe index list.

In some embodiments, before step 1, the first UE receive the configuration message from the network. The configuration message includes either or both configured information to NR and LTE sidelink coexistence interference indication to the peer UE, or configured information that provides NR and LTE sidelink coexistence assistance information.

### Embodiment 5

When the UE has a new transmission, retransmission and HARQ feedback, the network may not be able to completely stagger the NR sidelink transmission resources from the LTE reception resource pool based on the consideration of delay during scheduling. Therefore, when the UE determines that the NR sidelink transmission may cause strong interference with the reception of LTE sidelink, UE could consider giving up the NR sidelink transmission. On the other hand, when the UE determines that the LTE sidelink transmission may cause strong interference with the reception of NR sidelink, UE could also consider giving up the LTE sidelink transmission.
Step1: UE receives the configuration message from the network. The configuration message includes an indication that the UE is allowed to drop the sidelink transmission if the UE determines the associated transmission may cause strong interference with the reception of NR or LTE sidelink.
Step2: UE drops the sidelink transmission if the UE determines the associated transmission may cause strong interference with the reception of NR or LTE sidelink.

### Embodiment 6

In order to decrease the negative impacts of dropping the sidelink transmission due to NR sidelink and LTE sidelink coexistence, the UE shall consider the priority of the traffic when deciding whether to drop the sidelink transmission or not.

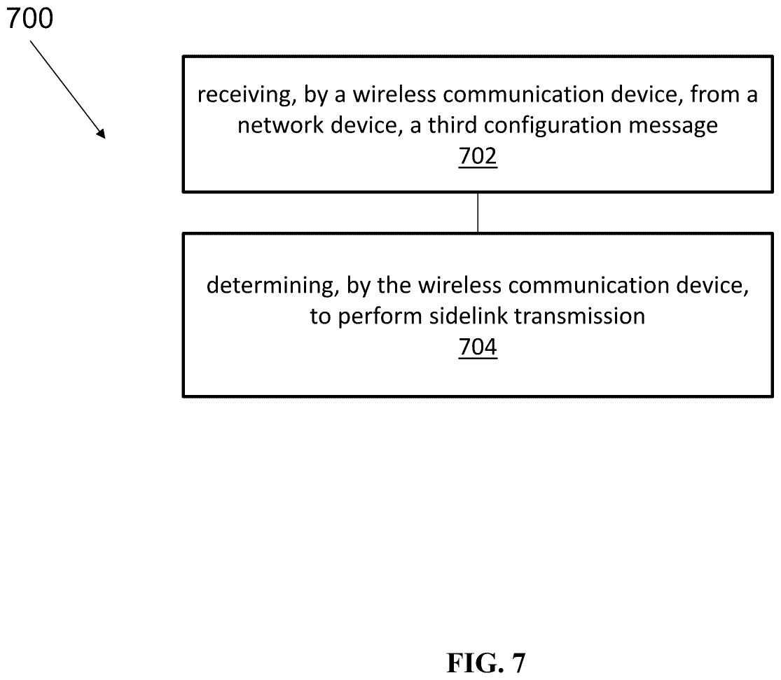

FIG. 7 illustrates a wireless communication comprising: receiving, by a wireless communication device, from a network device, a third configuration message (702); determining, by the wireless communication device, to perform sidelink transmission (704).

In some embodiments, the UE acquires the Priority threshold information. For example, UE receives the configuration message from the network, the configuration message includes the Priority threshold. In another example, UE is preconfigured with a Priority threshold information, or UE is specified with Priority threshold information. Thereafter, when the UE determines that the sidelink transmission may cause strong interference with the reception of NR or LTE sidelink, and if the priority of MAC PDU to be transmitted is lower than the Priority threshold, UE will drop the sidelink transmission.

In some embodiments, the UE acquires a first priority threshold and a second priority threshold information. For example, UE receives the configuration message from the network, the configuration message includes a first priority threshold and a second priority threshold, In another example, UE is preconfigured with a first priority threshold and a second priority threshold information, UE is specified with a first priority threshold and a second priority threshold information, e.g., the first priority threshold can be specified as value 1, or the second priority threshold can be specified as value 1.

Thereafter, when the UE determines that the sidelink transmission may cause strong interference with the reception of NR or LTE sidelink, and if the priority of MAC PDU to be transmitted is lower than the first Priority threshold, and if the priority of MAC PDU to be received is higher than the second Priority threshold, the UE will drop the sidelink transmission. For example, the UE can acquire the priority of MAC PDU to be received based on previous received SCI message which carries priority information and the resource information of the next new transmission or retransmission.

In some embodiments, the UE acquires a first priority threshold and a second priority threshold information. For example, UE receives the configuration message from the network, the configuration message includes a first priority threshold and a second priority threshold, or UE is preconfigured with a first priority threshold and a second priority threshold information, or UE is specified with a first priority threshold and a second priority threshold information, e.g., the first priority threshold can be specified as value 1, or the second priority threshold can be specified as value 1.

If the priority of MAC PDU to be received is unknown, the UE only consider the priority of MAC PDU to be transmitted, which is, when the UE determines that the sidelink transmission may cause strong interference with the reception of NR or LTE sidelink, and the priority of MAC PDU to be transmitted is lower than the first Priority threshold, the UE will drop the sidelink transmission.

In some embodiments, when the UE determines that the sidelink transmission may cause strong interference with the reception of NR or LTE sidelink, and if it can acquire the priority of MAC PDU to be received, and that the priority of MAC PDU to be transmitted is lower than the priority of MAC PDU to be received, the UE will drop the sidelink transmission.

### Embodiment 7

In order to decrease the negative impacts of dropping the sidelink transmission due to NR sidelink and LTE sidelink coexistence, the UE can consider the importance of the traffic when deciding whether to drop the sidelink transmission. For example, the re-transmission triggered by the NACK feedback is more important than the new transmission, or the new transmission is more important than the blind re-transmission which is not triggered by the NACK feedback. Thus, when the UE determines that the sidelink transmission may cause strong interference with the reception of NR or LTE sidelink, and that the MAC PDU to be transmitted is a new transmission or a blind re-transmission, and that the MAC PDU to be received is a re-transmission triggered by the NACK feedback, the UE will drop the sidelink transmission.

In some embodiments, the UE can consider both the priority threshold and new transmission or re-transmission of the traffic when deciding whether to drop the sidelink transmission. For example, as detailed in embodiment 6, the Priority threshold including the first priority threshold and the second priority threshold can be configured for new transmission or re-transmission separately.

The UE acquires a first Priority threshold for a new transmission and a second Priority threshold for a retransmission. For example, UE receives the configuration message from the network, the configuration message includes a first Priority threshold for a new transmission and a second Priority threshold for a retransmission. In another example, UE is preconfigured with a first Priority threshold for a new transmission and a second Priority threshold for a retransmission. In another example, a first Priority threshold for a new transmission and a second Priority threshold for a retransmission is specified.

Thereafter, when the UE determines that the sidelink transmission may cause strong interference with the reception of NR or LTE sidelink, and that the priority of MAC PDU to be transmitted is lower than the first Priority threshold if the MAC PDU is new transmission, the UE will drop the sidelink transmission; when the UE determines that the sidelink transmission may cause strong interference with the reception of NR or LTE sidelink, and the priority of MAC PDU to be transmitted is lower than the second Priority threshold if the MAC PDU is retransmission, the UE will drop the sidelink transmission;

### Embodiment 8

Since the UE may have a new transmission, a retransmission and HARQ feedback, the network may not be able to completely stagger the NR sidelink transmission resources from the LTE reception resource pool based on the consideration of delay during scheduling. Then, when the UE determines that the NR sidelink transmission may cause strong interference with the reception of LTE sidelink, the UE may consider to give up the NR sidelink transmission. On the other hand, when the UE determines that the LTE sidelink transmission may cause strong interference with the reception of NR sidelink, the UE may consider to give up the LTE sidelink transmission.

In order to decrease the negative impacts of dropping the sidelink transmission due to NR sidelink and LTE sidelink coexistence, the UE shall consider the dropping rate of the sidelink transmission when deciding whether to drop the sidelink transmission.

In some embodiments, the UE is configured with a maximum number of resources for which the UE is allowed to deny or drop NR/LTE SL transmission. Then the UE is allowed to deny or drop the NR/LTE SL transmission the number of which is less than the maximum number of resources. The resource can be one of the following: slot, subframe, sub-band or PRB.

The maximum number of resources can be received from the network or can be preconfigured in the UE.

In some embodiments, the UE can be configured with a maximum number of resources for which the UE is allowed to deny or drop NR/LTE SL transmission for each transmission sidelink resource pool. Then the UE is allowed to deny or drop the NR/LTE SL transmission the number of which is less than the maximum number of resources in the associated sidelink resource pool.

In some embodiments, the UE can be configured with a maximum number of resources and the period for which the UE is allowed to deny or drop NR/LTE SL transmission for a period. UE is allowed to deny or drop the number NR/LTE SL transmission over a period of time, of which the number is less than the maximum number of resources.

### Embodiment 9

Since the UE may have a new transmission, a retransmission and HARQ feedback, the network may not be able to completely stagger the NR sidelink transmission resources from the LTE reception resource pool based on the consideration of delay during scheduling. Then, when the UE determines that the NR sidelink transmission may cause strong interference with the reception of LTE sidelink, it could consider reduce the power of NR sidelink transmission. On the other hand, when the UE determines that the LTE sidelink transmission may cause strong interference with the reception of NR sidelink, it could consider reduce the power of LTE sidelink transmission.

The similar solution of embodiment 5-6 can be used, with the change of the solution of dropping the sidelink transmission to reduce the power of sidelink transmission.

### Embodiment 10

In some embodiments, for a UE configured with SL DRX for groupcast and/or broadcast, it may report the QoS profile(s) of the sidelink QoS flow(s) of the associated destination configured by the upper layer for the NR sidelink groupcast or broadcast communication reception. Since each SL DRX configuration is associated to one destination id, SL DRX cannot be used for some destination id. When serving cell does not know which SL DRX can or cannot be used, the UE reports the QoS profile(s) of the sidelink QoS flow(s) of the associated destination for which SL DRX can be used.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of a document that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this disclosure.

What is claimed is:

1. A method of wireless communication, comprising:
transmitting, by a wireless communication device, to a network device, a sidelink coexistence assistance information;
receiving, by a wireless communication device, from the network device, a configuration message according to the sidelink coexistence assistance information;
wherein the wireless communication device is in Radio Resource Control (RRC) connected state.

2. The method of claim 1, wherein the sidelink coexistence assistance information further indicating that the wireless communication device is configured with a first radio access technology (RAT) of sidelink and a second RAT of sidelink traffic.

3. The method of claim 2, wherein the sidelink coexistence assistance information comprising one or more of the following: carrier frequency, resource pool list, interference direction, victim system type, sub-band index list, and Bandwidth Part (BWP) index list.

4. The method of claim 2, wherein the sidelink coexistence assistance information comprising sidelink resource pool configuration information.

5. The method of claim 1, wherein the communication device receives, from the network device, a second configuration message;
wherein the second configuration message further comprising sensing configuration information.

6. The method of claim 5, wherein the second configuration message further comprising one or more of the following sensing configuration information: resource pool ID, sensing sub-channel number, sensing periodicity, sensing priority, RAT indication, and resource type indication.

7. The method of claim 5, wherein the second configuration message further comprising one or more of the following sidelink configuration information: resource pool ID, sensing sub-channel number, sensing periodicity, sensing priority, and resource type indication.

8. A method of wireless communication, comprising:
receiving, by a network device, from a wireless communication device, a sidelink coexistence assistance information;
transmitting, by a network device, to the wireless communication device, a configuration message according to the sidelink coexistence assistance information;
wherein the wireless communication device is in Radio Resource Control (RRC) connected state.

9. The method of claim 8, wherein the sidelink coexistence assistance information further indicating that the wireless communication device is configured with a first radio access technology (RAT) of sidelink and a second RAT of sidelink traffic.

10. The method of claim 9, wherein the sidelink coexistence assistance information comprising one or more of the following: carrier frequency, resource pool list, interference direction, victim system type, sub-band index list, and Bandwidth Part (BWP) index list.

11. The method of claim 9, wherein the sidelink coexistence assistance information comprising sidelink resource pool configuration information.

12. The method of claim 8, wherein the communication device receives, from the network device, a second configuration message;
wherein the second configuration message further comprising sensing configuration information.

13. The method of claim 12, wherein the second configuration message further comprising one or more of the following sensing configuration information: resource pool ID, sensing sub-channel number, sensing periodicity, sensing priority, RAT indication, and resource type indication.

14. The method of claim 12, wherein the second configuration message further comprising one or more of the following sidelink configuration information: resource pool ID, sensing sub-channel number, sensing periodicity, sensing priority, and resource type indication.

15. An apparatus for wireless communication comprising one or more processors, configured to cause the apparatus to:
transmit, by a wireless communication device, to a network device, a sidelink coexistence assistance information;
receive, by a wireless communication device, from the network device, a configuration message according to the sidelink coexistence assistance information;
wherein the wireless communication device is in Radio Resource Control (RRC) connected state.

16. The apparatus of claim 15, wherein the sidelink coexistence assistance information further indicating that the wireless communication device is configured with a first radio access technology (RAT) of sidelink and a second RAT of sidelink traffic.

17. The apparatus of claim 16, wherein the sidelink coexistence assistance information comprising one or more of the following: carrier frequency, resource pool list, interference direction, victim system type, sub-band index list, and Bandwidth Part (BWP) index list.

18. An apparatus for wireless communication comprising one or more processors, configured to cause the apparatus to:
receive, by a network device, from a wireless communication device, a sidelink coexistence assistance information;
transmit, by a network device, to the wireless communication device, a configuration message according to the sidelink coexistence assistance information;
wherein the wireless communication device is in Radio Resource Control (RRC) connected state.

19. The apparatus of claim 18, wherein the sidelink coexistence assistance information further indicating that the wireless communication device is configured with a first radio access technology (RAT) of sidelink and a second RAT of sidelink traffic.

20. The apparatus of claim 19, wherein the sidelink coexistence assistance information comprising one or more of the following: carrier frequency, resource pool list, interference direction, victim system type, sub-band index list, and Bandwidth Part (BWP) index list.
